(19) United States
(12) Patent Application Publication
(10) Pub. No.: US 2014/0360894 A1
(43) Pub. Date: Dec. 11, 2014

(54) Carpule to Store Lower Dosage Amount of Dental Anesthetic

(71) Applicant: Ethel Marlene Miles, Fredericksburg, VA (US)

(72) Inventor: Ethel Marlene Miles, Fredericksburg, VA (US)

(21) Appl. No.: 14/297,428

(22) Filed: Jun. 5, 2014

Related U.S. Application Data
(60) Provisional application No. 61/831,361, filed on Jun. 5, 2013.

(51) Int. Cl. A61J 1/06; A61C 19/08

(52) U.S. Cl. CPC A61J 1/062; A61C 19/08
USPC 206/63.5

(57) ABSTRACT

A carpule to store lower dosage amount of dental anesthetic solution includes a tubular extrusion, a stopper, a front cap, and a color-coded band. The front cap is connected with a front opening of the tubular extrusion while the stopper is slidably engaged with a rear opening of the tubular extrusion. An inner diaphragm of the front cap is exposed through a central opening of the front cap so that the dental needle can be traversed into the tubular extrusion through the inner diaphragm. Additionally, the cross-sectional diameter of the central opening is similar to the cross-sectional diameter of the front opening so that the front cap is able to provide an expanded surface area for the dental needle to traverse through.

The current application claims a priority to the U.S. Provisional Patent application Ser. No. 61/831,361 filed on Jun. 05, 2013.

### FIELD OF THE INVENTION

The present invention relates generally to dental anesthesia and sedation. More specifically, the present invention is a lower dosage dental anesthetic carpule that is designed to minimize wasted anesthetic solution prior to a procedure.

### BACKGROUND OF THE INVENTION

Dental procedures and treatments are commonly undertaken in order to maintain and improve overall oral health. Various local and general anesthesia options as well as sedation options are available for patients undergoing dental procedures in order to minimize discomfort and pain. Although many dental procedures do not require anesthesia or sedation, common treatments such as tooth extraction and endodontic (root canal) therapy require local anesthesia. The most often utilized local anesthetic is injected lidocaine for the purposes of numbing and otherwise desensitizing the treatment area. Dental anesthetic solution is most commonly stored within a sealed carpule that is loaded into a dental syringe prior to injection. The carpules allow the contained anesthetic solution to be optionally warmed prior to injection. Dental anesthetic carpules are generally standardized in terms of size as well as volume, often holding approximately 1.7 to 1.8 ml of solution. While this is acceptable and sufficient for the majority of adult patients, oftentimes the entire contents of a carpule are not required for a procedure. This is particularly the case for young children and/or elderly patients who do not require the full dosage of anesthetic solution contained within a carpule. As a result, oftentimes only a portion of the anesthetic solution is used while the remaining solution is discarded. Over time, this wasteful practice leads to accumulated costs for partially used and discarded dental anesthetics. Additionally, full-sized dental carpules are potentially intimidating for children and parents of children who require anesthesia prior to a procedure, but are presented with the same full dosage carpules used for adults. The present invention seeks to address the aforementioned issues and provide a more practical and efficient solution.

The present invention is a lower dosage dental anesthetic carpule for minimizing wasted anesthetic solution when a standard full dosage is not required. In its preferred embodiment, the present invention comprises a tubular carpule containing dental anesthetic solution within its hollow interior channel. The front end of the carpule is sealed by a cap with rubber diaphragm. The rear end of the carpule is sealed by a rubberized stopper that may be depressed to expel the anesthetic solution through the punctured front end of the carpule. The present invention is available in two primary configurations: miniature carpule with standard size rubberized stopper and standard carpule with large size rubberized stopper. Each embodiment of the present invention is designed to accommodate approximately 1.0 ml of dental anesthetic solution in contrast to the standard full-sized dosage of 1.7 to 1.8 ml. The lower dosage dental anesthetic carpule is loaded into the breach of a dental syringe prior to injection. The rear end of the carpule is oriented toward the plunger of the syringe. The front end rubber diaphragm of the carpule is engaged and penetrated with the needle of the syringe. The rear end rubberized stopper is engaged by the harpoon of the syringe and may be depressed in order to expel anesthetic solution through the front end of the carpule into the needle. Due to the plunger injection mechanism of the syringe plunger, the breech may be adjusted to accommodate both a miniature size carpule and a standard size carpule.

### BRIEF DESCRIPTION OF THE DRAWINGS

FIG. 1 is a perspective view of the present invention.

FIG. 2 is a side view of the present invention.

FIG. 3 is a side view of the tubular extrusion of the present invention.

FIG. 4 is a perspective view of the front cap of the present invention.

FIG. 5 is a front view of the front cap of the present invention, showing the plane upon which a cross sectional view is taken shown in FIG. 6.

FIG. 6 is a cross section view of the front cap of the present invention taken along line A-A of FIG. 5.

FIG. 7 is a perspective view of the stopper of the present invention.

FIG. 8 is a side view of the stopper of the present invention.

FIG. 9 is a front view of the present invention, showing the plane upon which a cross sectional view is taken shown in FIG. 10.

FIG. 10 is a cross section view of the present invention taken along line B-B of FIG. 9.

FIG. 11 is a cross section view for the front portion of the tubular extrusion and outer-sealing ring of the present invention, showing the cross-sectional diameter of the front opening and the central opening.

FIG. 12 is a perspective view of the miniature and standard configuration of the present invention.

### DETAIL DESCRIPTIONS OF THE INVENTION

All illustrations of the drawings are for the purpose of describing selected versions of the present invention and are not intended to limit the scope of the present invention.

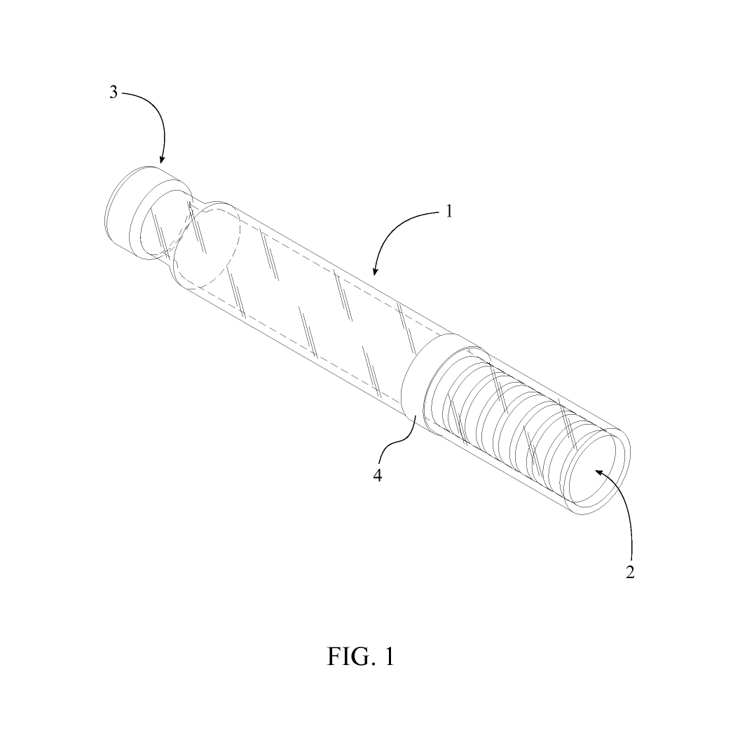

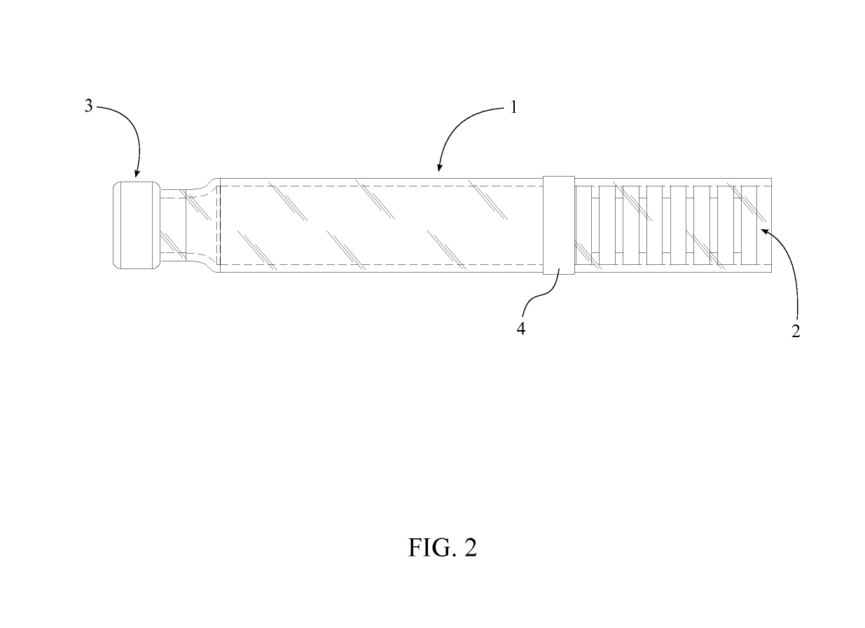

The present invention is a carpule that stores lower dosage amount of dental anesthetic solution to accommodate patients who do not want or require a full adult dosage of dental anesthetic solution prior to a procedure. As a result, the present invention is able to minimize wasted dental anesthetic solution. In its preferred embodiment, the present invention comprises a dental anesthetic carpule that is available in both miniature size and standard size configurations, where the present invention accommodates approximately 1.0 ml of dental anesthetic solution in contrast to the standard full-sized dosage of 1.7 to 1.8 ml. In reference to FIG. 1 and FIG. 2, the present invention comprises a tubular extrusion 1, a stopper 2, a front cap 3, and a color-coded band 4, where the front cap 3 is adjacently connected with a front opening 13 of the tubular extrusion 1 while the stopper 2 is slidably engaged with a rear opening 14 of the tubular extrusion 1 opposite of the front cap 3. The present invention is used in conjunction with a dental needle and a dental syringe so that the stored dental anesthetic solution can be expelled from the present invention.

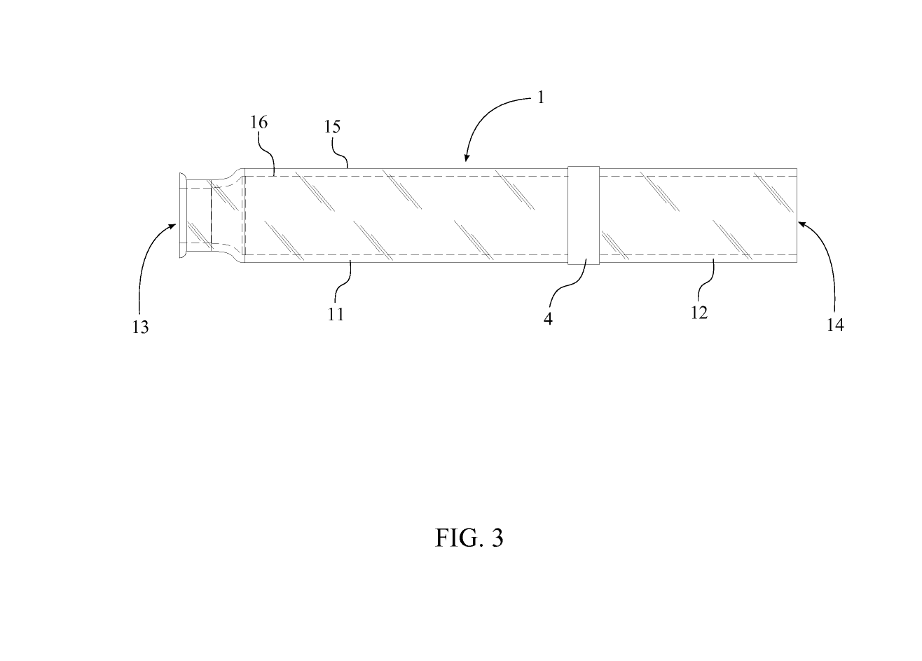

In reference to FIG. 3, the tubular extrusion 1 that stores the dental anesthetic solution comprises a front-half portion 11, a rear-half portion 12, an outer annular surface 15, and an inner annular surface 16. The front-half portion 11 and the rear-half portion 12 are axially positioned opposite of each other, where the front-half portion 11 and the rear-half portion 12 form the tubular extrusion 1. The front opening 13 is concentrically positioned with the front-half portion 11 and oppositely positioned from the rear-half portion 12. Similarly, the rear opening 14 is concentrically positioned with the rear-half portion 12 and oppositely positioned from the front-half portion 11. The outer annular surface 15 and the inner annular surface 16 are extended from the front opening 13 to the rear opening 14 along the front-half portion 11 and the rear-half portion 12 in such a way that the outer annular surface 15 and the inner annular surface 16 are positioned concentric with each other. In the preferred embodiment of the present invention, the front opening 13 and the front-half portion 11 area adjacent to the front opening 13 comprise a smaller cross-sectional diameter than that the remaining portion of the tubular extrusion 1, creating a neck area for the tubular extrusion 1. The tubular extrusion 1 is preferably made from glass in order to prevent any kind of contaminations. Even though the tubular extrusion 1 preferably made from glass, the tubular extrusion 1 can be made from any other type material as long as the material does not react with the dental anesthetic solution.

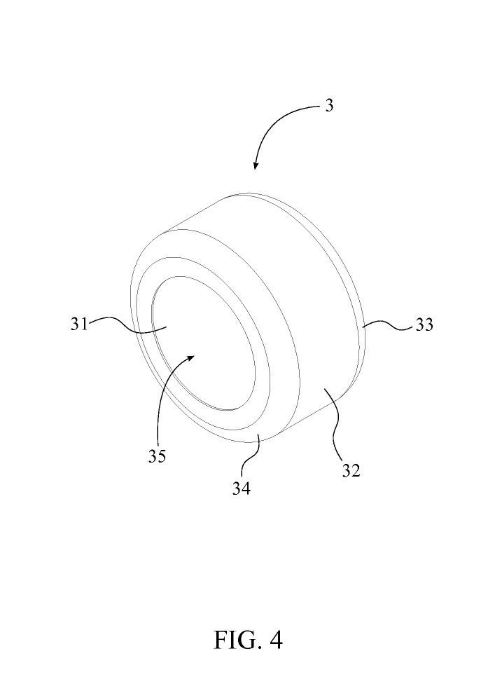

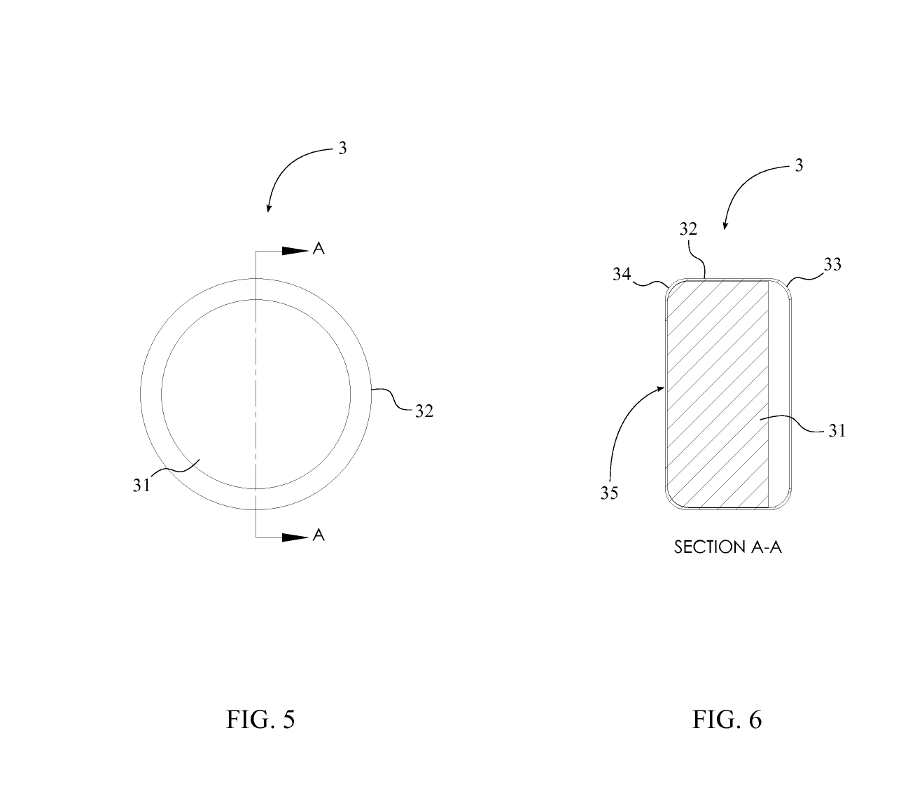

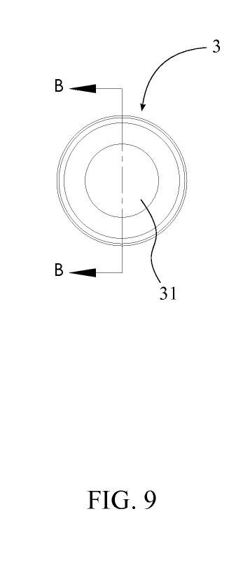

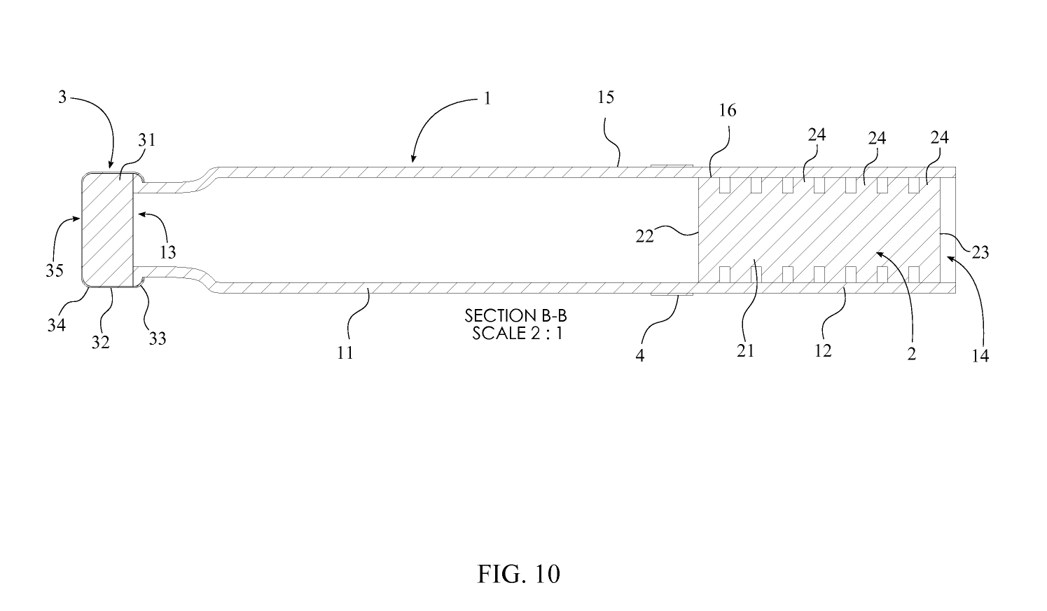

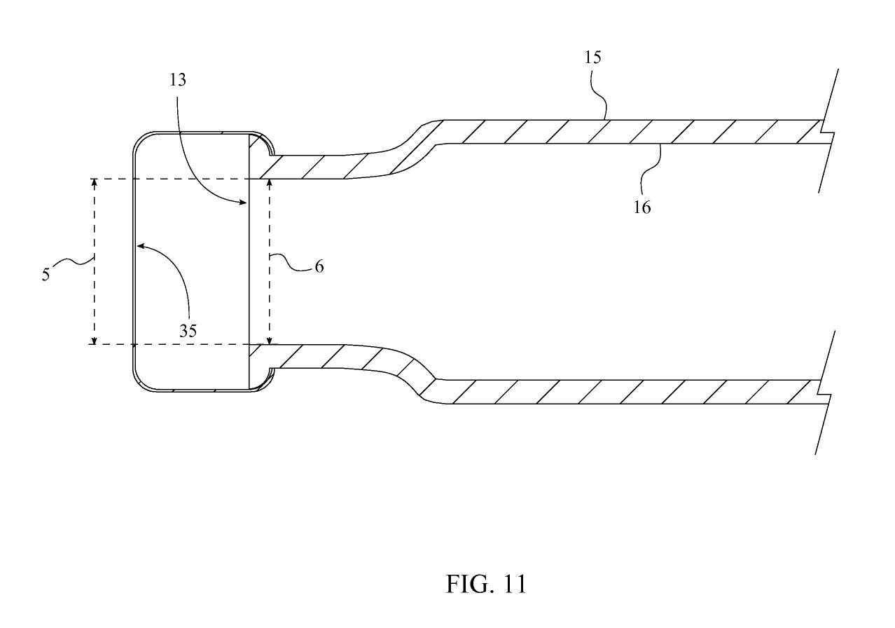

In reference to FIG. 4, FIG. 5, and FIG. 6, the front cap 3, which seals the tubular extrusion 1 from one end, comprises an inner diaphragm 31, an outer-sealing ring 32, and a central opening 35. The inner diaphragm 31 is adjacently and concentrically positioned with the front opening 13, where the inner diaphragm 31 is positioned flush with the outer annular surface 15. In reference to FIG. 9 and FIG. 10, the outer-sealing ring 32 is perimetrically positioned around the front opening 13 and the inner diaphragm 31, where that the outer-sealing ring 32 compresses the inner diaphragm 31 into the front opening 13. As a result, the inner diaphragm 31 and the outer-sealing ring 32 are able to close the tubular extrusion 1 from one end. More specifically, a first flange 33 of the outer-sealing ring 32 is perimetrically connected around the front opening 13, and a second flange 34 of the outer-sealing ring 32 is perimetrically connected around the inner diaphragm 31. The central opening 35 is concentrically positioned within the second flange 34, where the central opening 35 exposes the inner diaphragm 31 so that the dental needle can be traversed into the tubular extrusion 1 through the inner diaphragm 31. In reference to FIG. 11, a cross-sectional diameter 5 of the central opening 35 is equal to a cross-sectional diameter 6 of the inner annular surface 16 for the front opening 13 so that the front cap 3 is able provide an expand surface area for the dental needle traverse through. The inner diaphragm 31 is made from semi-permeable materials such as rubber and silicon so that the dental needle is able to traverse through the inner diaphragm 31 without any complication. The outer-sealing ring 32 can be made from high strength metals such as aluminum, brass, or copper so that the outer-sealing ring 32 is able compress the inner diaphragm 31 into the front opening 13.

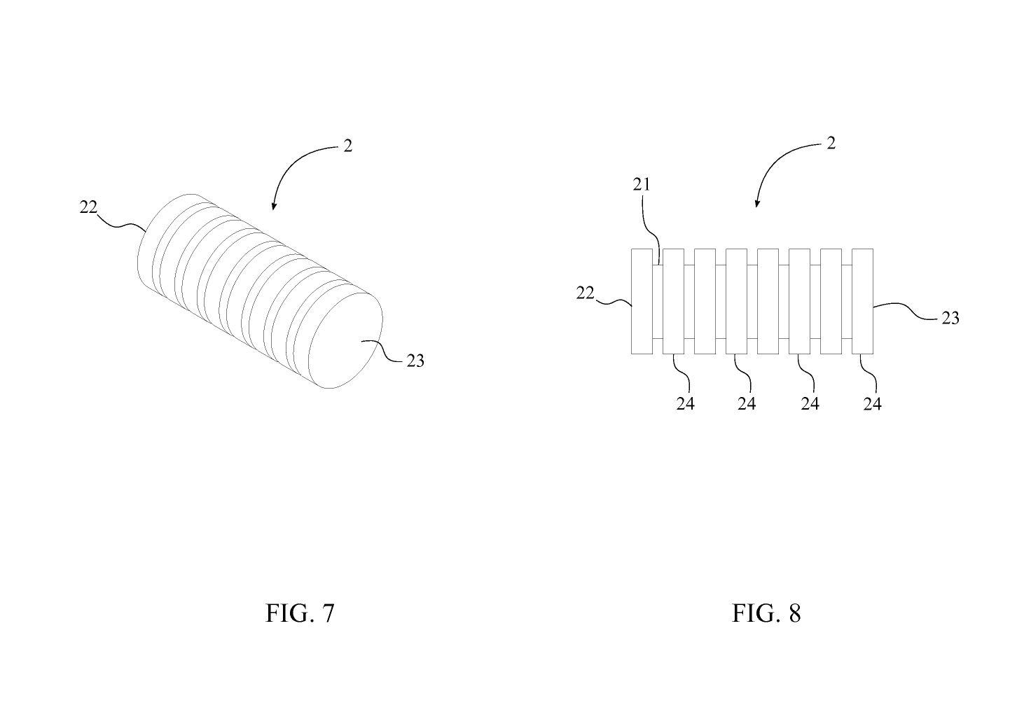

In reference to FIG. 7 and FIG. 8, the stopper 2, which seals the tubular extrusion 1 opposite of the front cap 3, comprises an elongated body 21, a first extremity 22, a second extremity 23, and a plurality of circular tabs 24. The first extremity 22 and the second extremity 23 are oppositely positioned from each other along the elongated body 21 as the plurality of circular tabs 24 is radially extended around the elongated body 21. Each of the plurality of circular tabs 24 is axially positioned in between the first extremity 22 and the second extremity 23 in such a way that the plurality of circular tabs 24 firmly maintains the engagement in between the stopper 2 and the rear opening 14. In reference to FIG. 9 and FIG. 10, the plurality of circular tabs 24 is pressed against the inner annular surface 16 adjacent to the rear opening 14 as the first extremity 22 adjacently positions with the first-half portion while the second extremity 23 adjacently positions with the rear opening 14. The stopper 2 is preferably made from rubber or silicon so that the stopper 2 is able to slide along the inner annular surface 16 without damaging the tubular extrusion 1.

In reference to FIG. 3, the color-coded band 4 is radially positioned around the rear-half portion 12, where the color coded band 4 allows the users to quickly determine the drug contents of the present invention. In other words, different color-coded bands 4 indicate different drug content of the dental anesthetic solution and may comprise:

1) Red: Lidocaine 2% (Epinephrine concentration 1:100,000)

2) Green: Lidocaine 2% (Epinephrine concentration 1:50,000)

3) Purple/Light blue: Lidocaine

4) Dark brown: Mepivacaine 2% (Levonordefrin concentration 1: 20,000)

5) Light brown: Mepivacaine 3%

6) Yellow: Prilocaine 4% (Epinephrine concentration 1:200,000)

7) Black: Prilocaine 4%

8) Dark blue: Bupivacaine 0.5% (Epinephrine concentration 1:200,000)

9) Dark gray: Articaine 4% (Epinephrine concentration 1:100,000)

10) Light gray: Articaine 4% (Epinephrine concentration 1:200,000)

When the present invention is inserted into the dental syringe, the dental needle is able to traverse into the tubular extrusion 1 through the front cap 3 while the harpoon for the plunger injection mechanism of the dental syringe engages with the stopper 2. Then the dental anesthetic solution that is stored within the tubular extrusion 1 is expelled through the dental needle as the harpoon pushes the stopper 2 toward the front opening 13. This causes the stopper 2 to traverse along the inner annular surface 16 and expel the dental anesthetic solution out of the dental needle. The dental syringe may accommodate both the miniature size and standard size configurations due to the plunger injection mechanism of the dental syringe and the resulting adjustability of the breech of the dental syringe.

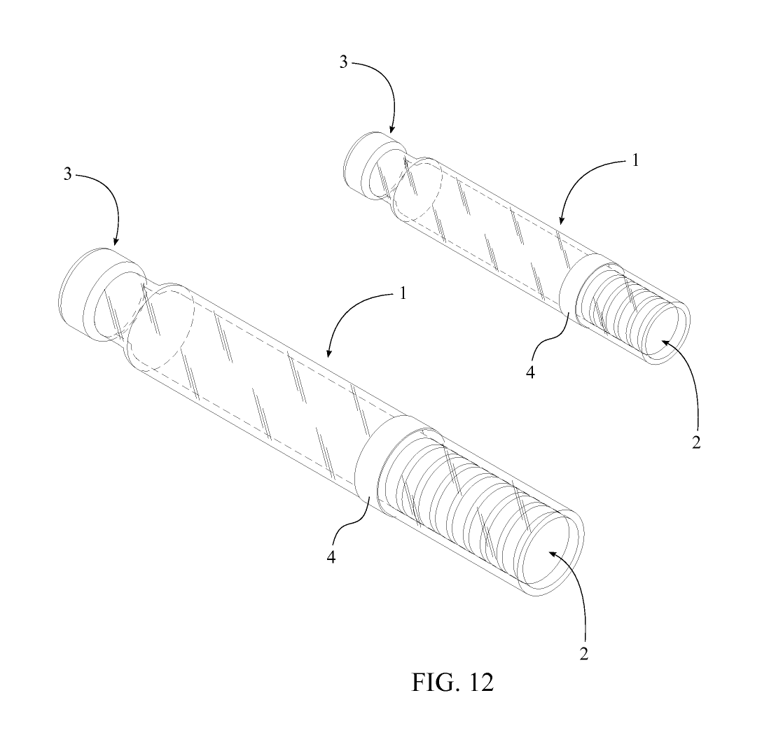

The object of the present invention is to provide dental patients with a lower dosage of dental anesthetic prior to a procedure. In reference to FIG. 12, the present invention provides a lower dosage of dental anesthetic to patients such as young children and the elderly patients who may not require or want a full-sized adult dosage. As a result, the present invention directly results in reduced waste of unused dental anesthetic solution where only a portion of the dental anesthetic solution is used. In order to accommodate the reduced amount of dental anesthetic solution in the miniature size configuration, the stopper 2 of the miniature size configuration is sized accordingly so that the tubular extrusion 1 of the miniature size configuration is able store approximately 1.0 ml of dental anesthetic solution. In reference to the standard size configuration of the present invention, the stopper 2 is formed with a larger length to reduce the volume within the tubular extrusion 1 so that stored amount of dental anesthetic solution can be reduced to 1.0 ml.

Although the invention has been explained in relation to its preferred embodiment, it is to be understood that many other possible modifications and variations can be made without departing from the spirit and scope of the invention as hereinafter claimed.

What is claimed is:

1. A carpule to store lower dosage amount of dental anesthetic comprises:
a tubular extrusion;
a stopper;
a front cap;
a color-coded band;
the tubular extrusion comprises a front-half portion, a rear-half portion, a front opening, a rear opening, an outer annular surface, and an inner annular surface;
the stopper comprises an elongated body, a first extremity, a second extremity, and a plurality of circular tabs;
the front cap comprises an inner diaphragm, an outer-sealing ring, and a central opening;
the front opening and the rear opening being oppositely positioned from each other along the tubular extrusion;
the front cap being adjacently connected with the front opening; and
the stopper being slidably engaged with the rear opening.

2. The carpule to store lower dosage amount of dental anesthetic as claimed in claim 1 comprises:
the front-half portion and the rear-half portion being axially positioned opposite of each other;
the front opening being concentrically positioned with the front-half portion;
the front opening being oppositely positioned from the rear-half portion;
the rear opening being concentrically positioned with the rear-half portion; and
the rear opening being oppositely positioned from the front-half portion.

3. The carpule to store lower dosage amount of dental anesthetic as claimed in claim 1 comprises:
the outer annular surface being extended from the front opening to the rear opening along the front-half portion and the rear-half portion;
the inner annular surface being extended from the front opening to the rear opening along the front-half portion and the rear-half portion; and
the outer annular surface and the inner annular surface being concentrically positioned with each other.

4. The carpule to store lower dosage amount of dental anesthetic as claimed in claim 1 comprises:
the inner diaphragm being adjacently and concentrically positioned with the front opening;
the inner diaphragm being positioned flush with the outer annular surface;
a first flange of the outer-sealing ring being perimetrically connected around the front opening
a second flange of the outer-sealing ring being perimetrically connected around the inner diaphragm; and
the central opening being concentrically positioned within the second flange.

5. The carpule to store lower dosage amount of dental anesthetic as claimed in claim 1, wherein a cross-sectional diameter of the central opening being equal to a cross-sectional diameter of the inner annular surface for the front opening.

6. The carpule to store lower dosage amount of dental anesthetic as claimed in claim 1 comprises:
the first extremity and the second extremity being oppositely positioned from each other along the elongated body;
the plurality of circular tabs being radially extended around the elongated body; and
each of the plurality circular tabs being axially positioned in between the first extremity and the second extremity.

7. The carpule to store lower dosage amount of dental anesthetic as claimed in claim 1 comprises:
the plurality of circular tabs being pressed against the inner annular surface;
the first extremity being adjacently positioned with the front-half portion; and
the second extremity being adjacently positioned with the rear opening.

8. The carpule to store lower dosage amount of dental anesthetic as claimed in claim 1, wherein the color-coded band being radially positioned around the rear-half portion.

9. A carpule to store lower dosage amount of dental anesthetic comprises:
a tubular extrusion;
a stopper;
a front cap;
a color-coded band;
the tubular extrusion comprises a front-half portion, a rear-half portion, a front opening, a rear opening, an outer annular surface, and an inner annular surface;
the stopper comprises an elongated body, a first extremity, a second extremity, and a plurality of circular tabs;
the front cap comprises an inner diaphragm, an outer-sealing ring, and a central opening;
the front opening and the rear opening being oppositely positioned from each other along the tubular extrusion;
the front cap being adjacently connected with the front opening;
the stopper being slidably engaged with the rear opening; and
a cross-sectional diameter of the central opening being equal to a cross-sectional diameter of the inner annular surface for the front opening.

10. The carpule to store lower dosage amount of dental anesthetic as claimed in claim 9 comprises:
the front-half portion and the rear-half portion being axially positioned opposite of each other;
the front opening being concentrically positioned with the front-half portion;
the front opening being oppositely positioned from the rear-half portion;
the rear opening being concentrically positioned with the rear-half portion; and
the rear opening being oppositely positioned from the front-half portion.

11. The carpule to store lower dosage amount of dental anesthetic as claimed in claim 9 comprises:
the outer annular surface being extended from the front opening to the rear opening along the front-half portion and the rear-half portion;
the inner annular surface being extended from the front opening to the rear opening along the front-half portion and the rear-half portion; and
the outer annular surface and the inner annular surface being concentrically positioned with each other.

12. The carpule to store lower dosage amount of dental anesthetic as claimed in claim 9 comprises:
the inner diaphragm being adjacently and concentrically positioned with the front opening;
the inner diaphragm being positioned flush with the outer annular surface;
a first flange of the outer-sealing ring being perimetrically connected around the front opening
a second flange of the outer-sealing ring being perimetrically connected around the inner diaphragm; and
the central opening being concentrically positioned within the second flange.

13. The carpule to store lower dosage amount of dental anesthetic as claimed in claim 9 comprises:
the first extremity and the second extremity being oppositely positioned from each other along the elongated body;
the plurality of circular tabs being radially extended around the elongated body; and
each of the plurality circular tabs being axially positioned in between the first extremity and the second extremity.

14. The carpule to store lower dosage amount of dental anesthetic as claimed in claim 9 comprises:
the plurality of circular tabs being pressed against the inner annular surface;
the first extremity being adjacently positioned with the front-half portion; and
the second extremity being adjacently positioned with the rear opening.

15. The carpule to store lower dosage amount of dental anesthetic as claimed in claim 9, wherein the color-coded band being radially positioned around the rear-half portion;

16. A carpule to store lower dosage amount of dental anesthetic comprises:
a tubular extrusion;
a stopper;
a front cap;
a color-coded band;
the tubular extrusion comprises a front-half portion, a rear-half portion, a front opening, a rear opening, an outer annular surface, and an inner annular surface;
the stopper comprises an elongated body, a first extremity, a second extremity, and a plurality of circular tabs;
the front cap comprises an inner diaphragm, an outer-sealing ring, and a central opening;
the front opening and the rear opening being oppositely positioned from each other along the tubular extrusion;
the front cap being adjacently connected with the front opening;
the stopper being slidably engaged with the rear opening;
a cross-sectional diameter of the central opening being equal to a cross-sectional diameter of the inner annular surface for the front opening; and
the color-coded band being radially positioned around the rear-half portion.

17. The carpule to store lower dosage amount of dental anesthetic as claimed in claim 16 comprises:
the front-half portion and the rear-half portion being axially positioned opposite of each other;
the front opening being concentrically positioned with the front-half portion;
the front opening being oppositely positioned from the rear-half portion;
the rear opening being concentrically positioned with the rear-half portion;
the rear opening being oppositely positioned from the front-half portion;
the outer annular surface being extended from the front opening to the rear opening along the front-half portion and the rear-half portion;
the inner annular surface being extended from the front opening to the rear opening along the front-half portion and the rear-half portion; and
the outer annular surface and the inner annular surface being concentrically positioned with each other.

18. The carpule to store lower dosage amount of dental anesthetic as claimed in claim 16 comprises:
the inner diaphragm being adjacently and concentrically positioned with the front opening;
the inner diaphragm being positioned flush with the outer annular surface;
a first flange of the outer-sealing ring being perimetrically connected around the front opening
a second flange of the outer-sealing ring being perimetrically connected around the inner diaphragm; and
the central opening being concentrically positioned within the second flange.

19. The carpule to store lower dosage amount of dental anesthetic as claimed in claim 16 comprises:
the first extremity and the second extremity being oppositely positioned from each other along the elongated body;
the plurality of circular tabs being radially extended around the elongated body;
each of the plurality circular tabs being axially positioned in between the first extremity and the second extremity;
the plurality of circular tabs being pressed against the inner annular surface;
the first extremity being adjacently positioned with the front-half portion; and
the second extremity being adjacently positioned with the rear opening.
